(19) United States
(12) Patent Application Publication
(10) Pub. No.: US 2008/0147514 A1
(43) Pub. Date: Jun. 19, 2008

(54) Instant or text message ordering and purchasing system

(75) Inventors: Brian Shuster, Las Vegas, NV (US); Edwin Sahakian, Los Angeles, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Clikit Technologies, Inc.

(21) Appl. No.: 12/002,423

(22) Filed: Dec. 17, 2007

Related U.S. Application Data
(60) Provisional application No. 60/875,711, filed on Dec. 18, 2006.
(60) Provisional application No. 60/881,394, filed on Jan. 18, 2007.
(60) Provisional application No. 60/898,355, filed on Jan. 30, 2007.
(60) Provisional application No. 60/921,705, filed on Apr. 3, 2007.
(60) Provisional application No. 60/928,819, filed on May 11, 2007.
(60) Provisional application No. 60/933,184, filed on Jun. 5, 2007.

(51) Int. Cl. G06Q 30/00; G06F 17/30

(52) U.S. Cl. 705/26

(57) ABSTRACT

A system and method which enables almost any device with text messaging capability to function as a consumer oriented remote shopping device. The consumer can make purchases using existing mobile services and devices. Using Short Message Service (SMS) or Instant Message (IM) or similar technology an order is placed and made ready to pick up at a retail location. The users' pre-approved credit card is charged for the amount of the transaction, and the order is routed to the store of choice. A printed receipt is triggered at the chosen retail location. Other embodiments include using a computer in a browser embodiment to generate a text message for placing an order. In another embodiment, commands are spoken into the phone which are then subsequently converted into text messages which are processed in the same manner as if the text message had been sent directly.

### CROSS-REFERENCE TO RELATED APPLICATIONS

This non-provisional application claims benefit to previously filed provisional application Ser. Nos. 60/875,711 filed Dec. 18, 2006, 60/881,394 filed Jan. 18, 2007, 60/898,355 filed Jan. 30, 2007, 60/921,705 filed Apr. 4, 2007, 60/928,819 filed May 11, 2007 and 60/933,184 filed Jun. 5, 2007.

### BACKGROUND

### Summary of the Invention

The present invention, in effect, allows almost any cell phone, smart phone or PDA with text messaging capability to function as a consumer oriented remote shopping device. The invention enables the consumer to makes purchases, on demand, using existing mobile services and devices. The consumer, as the user, does not need to know or use any intricate commands or even a web browser to enable and consummate retail based transactions.

Today's fast paced society demands quick responses, accurate transactions and simplified handling of routine tasks. Using the invention, a user can simply text message using Short Message Service (SMS) or Instant Message (IM) or similar technology an order from, for example, a cell phone for coffee, food, movies, pharmaceuticals, etc. and have it ready to pick up at a favorite coffee shop, restaurant, video store or other retail store or even have it delivered to a designated address. This transaction from the cell phone via SMS or IM is completely automated and secure. The users' pre-approved credit card is automatically charged for the exact amount of the transaction, and the order is automatically routed to the store of choice, and a printed receipt is automatically triggered at the chosen coffee shop, restaurant, video store, pharmacy, or other retail location. Rather than automatically charging a credit card, alternatively, the charged amount can be included on an invoice normally sent to the customer for the use of the mobile phone or similar device as an added charge.

By using the invention, one has the ability, via SMS or IM, to initiate and consummate transactions using a cell phone, PDA or similar device. The invention is an improvement over the current user experience where the consumer currently has to log on to access a web page, find the product, enter order details, enter credit card information and follow numerous additional steps to consummate a transaction.

The user simply needs to register a cell phone number, credit card information, and zip code with a service provider, and the user will then be able to SMS or IM orders for coffee, movies, sandwiches or pizza and the like from major chains across the country.

Other embodiments include using a desktop of laptop computer in a browser embodiment to generate a text message for placing an order by, for example, clicking on a desired product displayed in a pop-up window and then entering these same ordering information as would be the case when sending a text message. In another embodiment, instead of using a phone key pad to generate a text message, instead, commands are spoken into the phone which are then subsequently converted, using a voice-to-text recognition system, into text messages which would then be processed in the same manner as if the text message is sent directly from a phone. In another embodiment, in a desktop or laptop environment, transactional instant messaging software in the nature of a widget to initiate a purchase transaction is utilized.

### BRIEF DESCRIPTION OF THE FIGURES

FIG. 1 is a block overview diagram of a system which utilizes the present invention.

FIG. 2 is a block diagram showing the processing performed by transaction server 15 in accordance with the invention.

FIGS. 3a and 3b are block diagrams showing record structures of databases used by the invention.

FIGS. 4a, 4b and 5 are flow charts which show the processing steps performed by the invention.

FIG. 6 is a flow chart which shows processing steps performed by an embodiment of the invention in which voice commands are used.

### DETAILED DESCRIPTION OF THE INVENTION

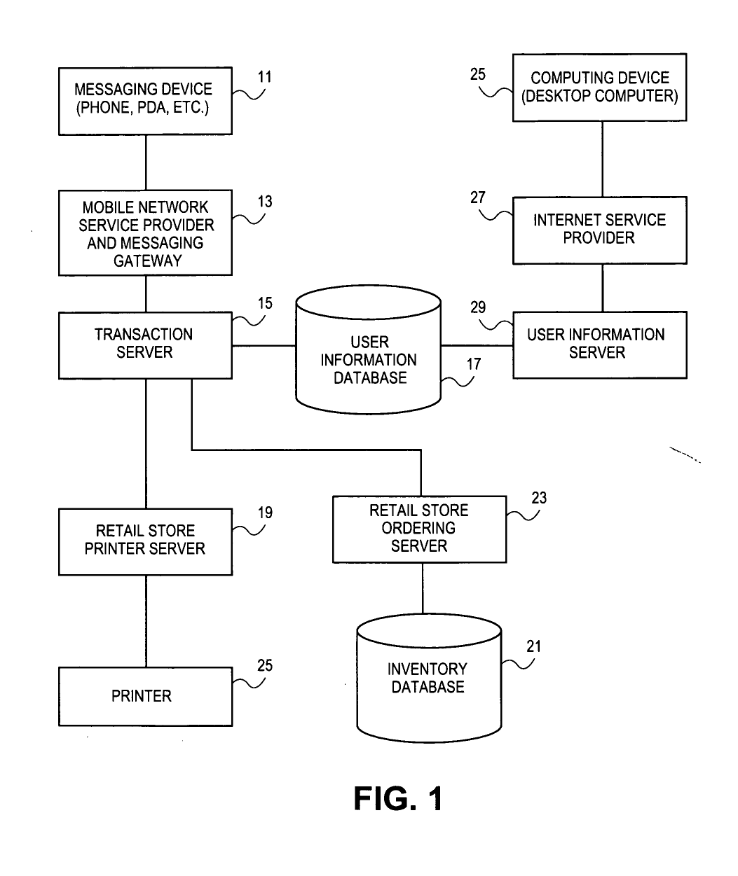

FIG. 1 shows the major elements of the invented system and the path a transaction will follow. The user initiates a purchase transaction from a messaging device such as a cell phone, smart phone, PDA or home computer 11 using an existing text messaging protocol such as SMS or IM. The information the consumer sends will then pass through a mobile network (if a mobile device is used) and a messaging gateway 13 to a transaction server 15. The transactions will then be processed where the user and credit card information will be verified by accessing a user information database 17. After verification the transaction will be sent to a retail store server 19 (located in a coffee shop, video store, pizza place, sandwich shop, etc.) where inventory and pricing information is obtained from an inventory database 21 using a retail store ordering server 23. If all is in order, the order will auto print on printer 25 via retail store print server 25 and a confirmation is sent to the transaction server 15. The transaction server 15 will send a message back through the same channels and the user will be notified on messaging device 11 that the order has been received, the amount that was charged to the user's designated credit card and that the user can pick up the order without waiting in line, or, if desired, the order can be delivered.

Further details regarding messaging device 11 are as follows. When the device is initiated, its display shows icons representing retail stores which can be selected by the user to place an order. Devices such as PDAs typically have a stylus and a touch sensitive screen such that if the user, using the stylus, touches a particular icon, such touch causes programming code to be executed which displays another screen and waits for user input. In the cell phone environment, a screen cursor movable by pressing keys of the device to move the cursor is moved until it is over a desired icon after which a selection is made by pressing a key on the device. Techniques for implementing such interfaces on such devices are well known to persons having ordinary skill in the art and, therefore, further details are not provided herein. Additionally, the messaging device may be a desktop or laptop computer. In such situation, it is well known that a text message can be sent using a web browser interface in which case software running on the computer sends entered data over the Internet to a device which can forward the data as a text message to a messaging device capable of receiving text messages.

Once an icon has been selected, an order entry screen is displayed appropriate for the selected store. Such order entry screen would enable the user to select or enter an item and quantity. For example, in the case of a coffee shop, the display would included choices such as coffee, cappuccino, latte or tea followed by ingredients such as sugar, cream, vanilla flavoring, etc. The specifics of the choices which would be displayed would of course depend upon the type of store and the items available from that store. The screen would also enable the user to indicate whether or not the order is complete. That is, since it is not practical on a relatively small screen display to place multiple different orders, once a particular order has been completed, that order would be sent as explained below, then the user could enter a second order, and then send the second order and enter another order until all desired orders have been placed.

The messaging device, using the information input by the user, formats the information into a text message. Usually, when sending text message, the user must specify the address of the receiving device. However, in this case, although the ordering information will ultimately be sent to a desired retail store, initially, the message is sent to transaction server 15 through the mobile network service provider and messaging gateway 13. In this connection, transaction server 15 is a system used by the invention to receive ordering information, determine the user who placed the order and the store to which the order is to be sent, and then initiate the order processing to the retail store.

FIG. 1 shows a path between messaging device 11 and mobile network service provider and messaging gateway 13. In this connection, mobile network service provider and messaging gateway 13 are existing systems maintained by cell phone companies and phone companies. If messaging device 11 is a computer or other device which does not need to go through a mobile provider, block 13 would be an Internet service provider and messaging gateway. Protocols required by such systems are well known and, for that reason, are not detailed herein. For purposes of the present invention, all that is required is that a text message is sent from messaging device 11 using well known SMS or IM protocols which message contains information necessary to place an order.

Transaction server 15, as far as messaging device 11 is concerned, is simply another messaging device capable of sending and receiving text messages. Thus, when a message is sent by messaging device 11 to transaction server 15, the address of transaction server 15 is included in the message. Typically, when a user sends an instant message from messaging device 1, it is necessary for the user to manually enter an address, or select an address, typically a phone number, from an address book contained within the messaging device. However, in the present invention, a program executing in messaging device 11 contains the necessary address for transaction server 15 and, for this reason, the address is not entered by the user.

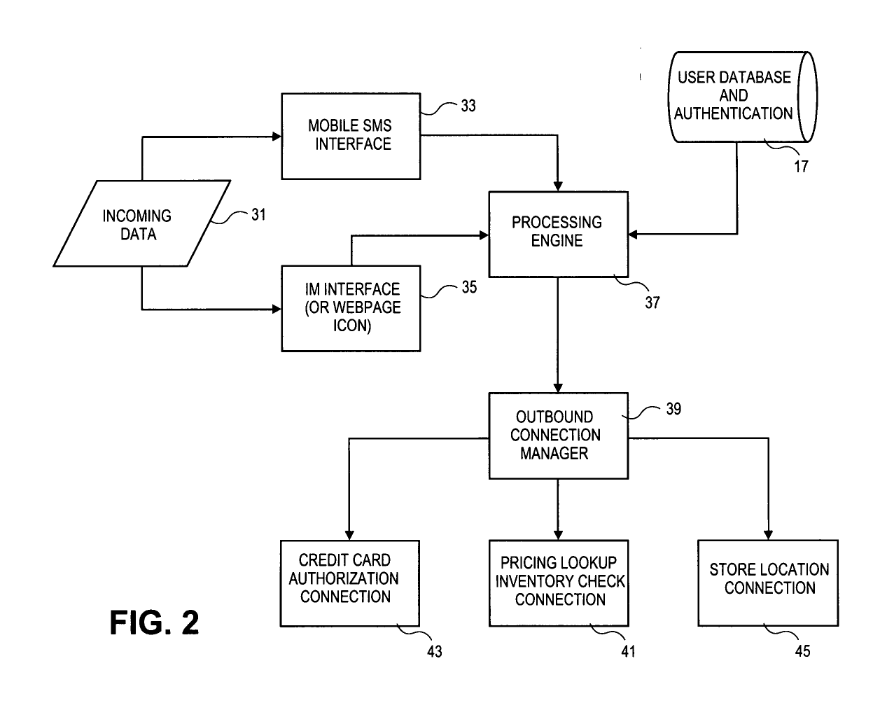

After transaction server 15 receives the text message sent by messaging device 11, reference is now made to FIG. 2 to explain the processing performed by transaction server 15. The received text message is shown as incoming data 31. Although FIG. 2 shows mobile SMS interface 33 and IM interface 35, the invention is not limited to these particular formats. At the present time, these are the most popular text messaging formats. Any other text messaging interface can be used in conjunction with the invention by providing an appropriate interface. Further, and as will be described below, the incoming data may be voice commands which are converted to text using a voice to text recognition system.

Depending upon the type of message (i.e., SMS or IM), interface 33 or interface 35 parses the message and extracts a user identification, store identification, and order information. Using the user information, user information database 17 is accessed by processing engine 37 to obtain credit card/debit card information for the user and retail store location information. This user preference information is set up in advance in user information database 17 as detailed below. Processing engine 37 then sends the obtained credit card/debit card information, store location information and order information to outbound connection manager 39. Using the store location information and order information, outbound connection manager initiates a communication with inventory check and pricing look up connection 41. Inventory check and pricing lookup connection 41 is an interface which accesses retail store ordering server 23. Specific details regarding these latter two systems are not detailed herein because the specifics of such system depend upon requirements of the retail store. However, such details are not necessary for an understanding of the present invention and those skilled in the art would be able to implement an inventory check and pricing look up connection 41 and retail store ordering server 23 in view of the description provided herein.

Essentially, all that is required is for inventory check and pricing look up connection 41 to access retail store ordering server 23 in order to verify that the order can be processed by the retail store, and obtain an amount to be charged for the order. Once this information is obtained, outbound connection manager 39, using existing systems, accesses credit card authorization connection 43 which communicates with an existing credit card/debit card provided to create a charge to the user's specified credit account. Once the charge has been authorized, outbound connection manager 39 causes the location connection 45 to generate an instant message identifying the user and i.e., customer and the order which was placed which is sent to retail store printer server 19. Outbound connection manager 39 also causes an instant message to be sent to messaging device 11 to let the user/customer know that the order has been placed, and the credit card charged.

### Inventory Management Process

In another embodiment, the transaction server checks for inventory from its own local database or a 3^{rd} party database depending on where the inventory information is stored. If the data is stored locally, the server will make direct calls to the database server using the database native API (application program interface) (Oracle, MySQL, SQL Server). If the data is stored at a 3^{rd} party database server, a web service call to the 3^{rd} party database server is made. This process is customized for each 3^{rd} party since different systems and application platforms will be used. It would be required to build a thin API (application program interface) layer to support the following API calls and support the requested parameters:

Type of API Calls
Check Inventory
   Method for retrieving the availability of one or more products or services with the following request parameters
      Security Credentials (If required)
      Product Name or (ID number)
      Requested count
      Optional Availability Date
      Optional Store Location
Confirm Purchase
   Method for confirming a purchase of a product or service so the inventory can be updated with the following request parameters
      Security Credentials (If required)
      Product Name of (ID number)
      Purchased count
      Type of purchase (On Hold, Sold, Item Returned, etc. . . . )

### Web API

If 3^{rd} parties need to access the inventory data of local databases, A web API and Web Portal will be available.

The Web API is as follows:
Check Inventory
   Method for retrieving the availability of one or more products or services with the following request parameters
      Security Credentials (If required)
      Client Name
      Product Name or (ID number)
      Requested count
      Optional Availability Date
      Optional Store Location

### The Web portal is a web page that allows lookup of inventory data.

Referring again to FIG. 1, it should be understood that retail store ordering server 23 while not necessarily an existing system, when not existing, would need to be installed at a retail store for use by the invention. In some situations, such as a video store, such a system may already exist since it is needed to determine the store's inventory of videos and whether a particular video is in the store or currently checked out. Such an existing server would need to be modified slightly to enable access by transaction server 15. Typically, the modifications necessary for such access would be relatively minor and the details well within the knowledge of persons skilled in the art. The specifics of the inventory database 21 would depend upon the implementation of retail store order server 23. Additionally, in some cases such as for a coffee shop, there typically would be no need for an inventory database 21, since, at least for the purpose of placing orders, typically a coffee shop would know how much coffee, sugar, or cream, etc. it needs to operate each business day.

Retail printer server 19 would typically be implemented as software running on a desktop computer having access to an existing messaging gateway (not shown) so that instant messages sent from transaction server 15 can be received, formatted and sent to printer 15. It is well within the abilities of persons skilled in the art to create appropriate software to receive instant messages, format the instant messages into a form usable by a printer, and send the data to printer 25. Printer 25 can be implemented using, for example, a thermal printer 3″ wide paper with USB printing support such as a Samsung Bixolon SRP-350.

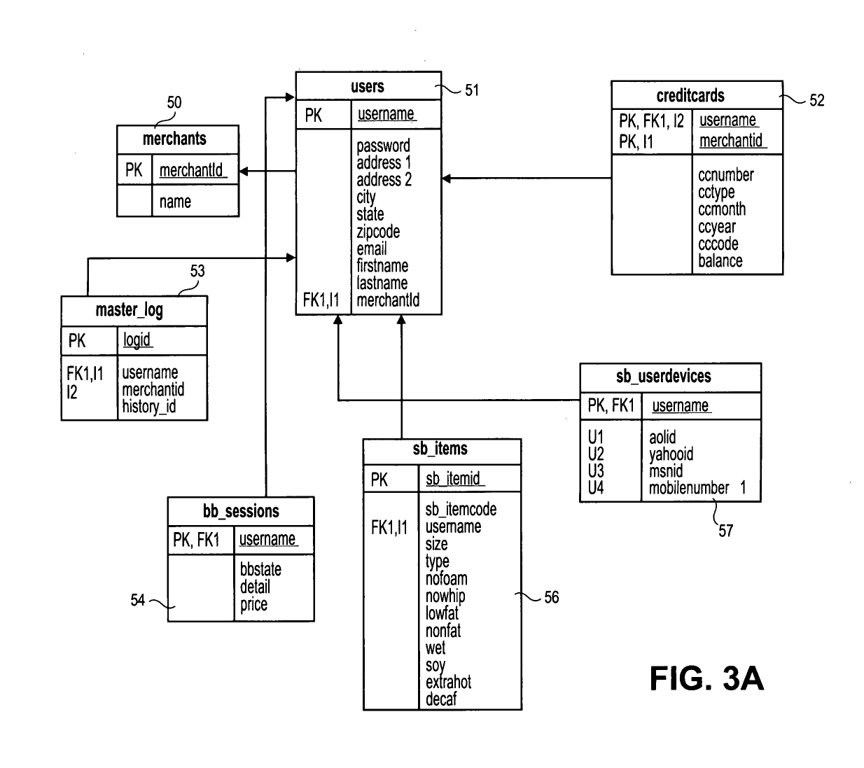

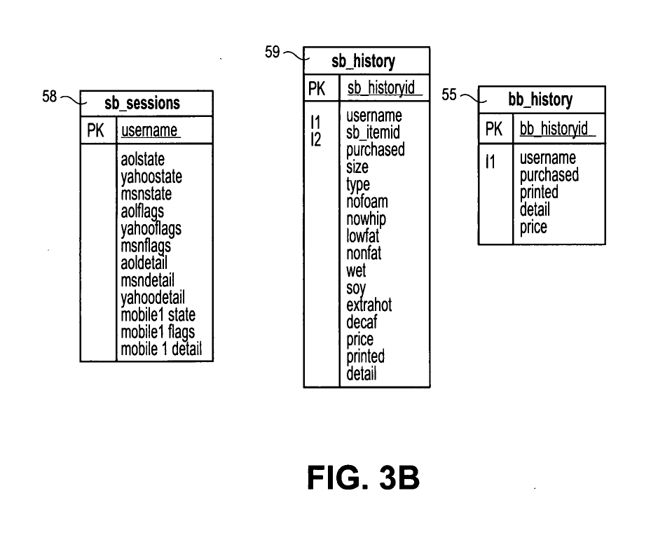

Further details regarding databases and data used to implement the invention will now be described with reference to FIGS. 3a and 3b. FIGS. 3a and 3b show various database records used in the invention. These records are merchants 50, users 51, credit cards 52, master log 53, bb_sessions 54, bb_history 55, sb_items 56, sb_userdevices 57, and sb_history 59. The records which begin with sb are for a coffee shop retail store. The records which begin with bb are for a video rental retail store. Other types of retail stores will have records with more or fewer fields specific to the type of retail operation. Thus, the bb and sb records are described as an example, but different records needed for different applications should be readily apparent to persons skilled in the art.

For each of the records used in the system as shown in FIGS. 3a and 3b, the following in an explanation as to what the various fields mean and how they are used.

### Merchants

merchandid (unique integer value for each merchant)
name (name of the merchant)

### Users

username (unique username)
password (password for the user)
personal information fields (address, city state, email)
merchantid (what merchant does this user belong to)

### Credit Cards

username (unique username)
merchantid (for what merchant is this credit card info belonging)
ccnumber (credit card number)
cctype (credit card type VISA, MC, AMEX)
ccmonth (expiration month)
ccyear (expiration year)
cccode (addional security code)
balance (remaining balance)

### Master Log

logid (unique log id)
username (unique username)
merchantid (what merchant this logging info belonging)
history_id (link to merchange specific transaction record)

### Bb_sessions (active video store sessions)

username (unique username)
state (state of session, active, expired)
detail (support information and custom session data)
price (total price for current transaction)

### Bb_history (video store order history)

username (unique username)
history_id (log id for linking to logs table)
purchased (date of purchase)
detail (transaction detail)
printed (order printed to a printer)
price (total for transaction)

### Sb_items (coffee shop menu items for each user)

sb_itemid (unique item id)
sb_itemcode (web or IM, SMS short code for this item)
username (unique username)
size (size of coffee)
type (type of coffee)
nofoam (no foam added)
nowhip (no whip cream added)
lowfat (low fat milk)
nonfat (non fat milk)
wet (wet style coffee)
soy (soy milk)
extrahot (prepared extra hot)
decaf (decaffeinated)

### Sb_userdevices (methods of ordering for each username SMS, IM, WEB)

username (unique username)
aolid (America Online id)
yahooed (Yahoo Messanger id)
msnid (MSN id)
mobilenumber (mobile number)

### Sb_history (coffee shop transaction history)

username (unique username)
sb_historyid (log id for linking to logs table)
purchased (date of purchase)
detail (transaction detail)
printed (order printed to a printer)
sb_itemid (unique item id)
size (size of coffee)
type (type of coffee)
nofoam (no foam added)
nowhip (no whip cream added)
lowfat (low fat milk)
nonfat (non fat milk)
wet (wet style coffee)
soy (soy milk)
extrahot (prepared extra hot)
decaf (decaffeinated)

FIG. 1 also shows computing device 25, Internet service provider 27 and user information server 29. Computing device 25 is a typical personal computer with a web browser and Internet access via Internet service provider 27 as is well known in the art. User information server 29 is a secure web server which displays to a user a web page enabling the user to enter desired preference information such as a credit card, and desired retail store locations. Further details regarding retail store preference information are described above with reference to FIGS. 3a and 3b. The details for implementing such a web server are well known to persons skilled in the art. Once such preference information is set up, a user is considered to be a registered user for all applications of the invented system.

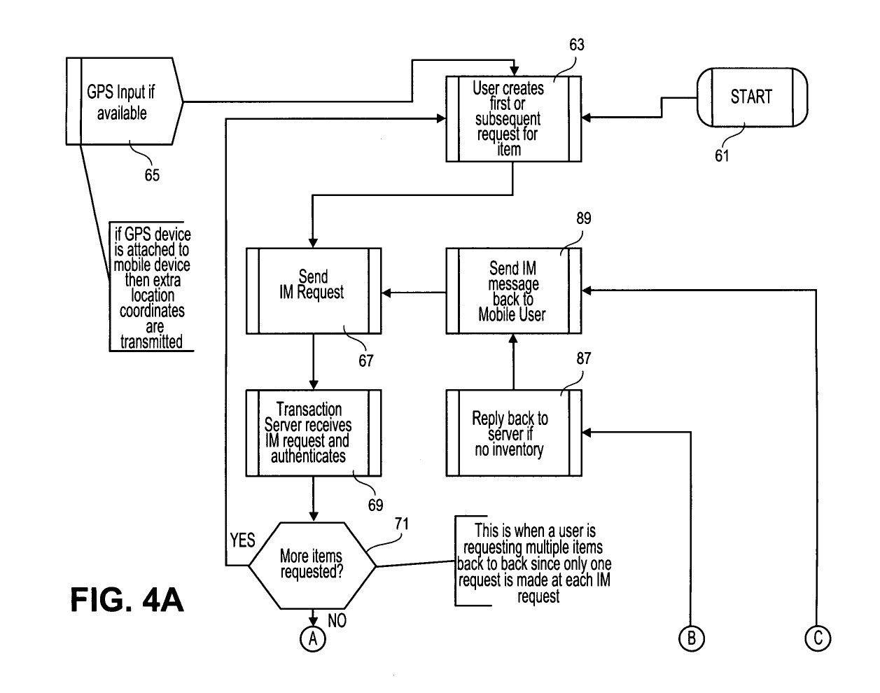

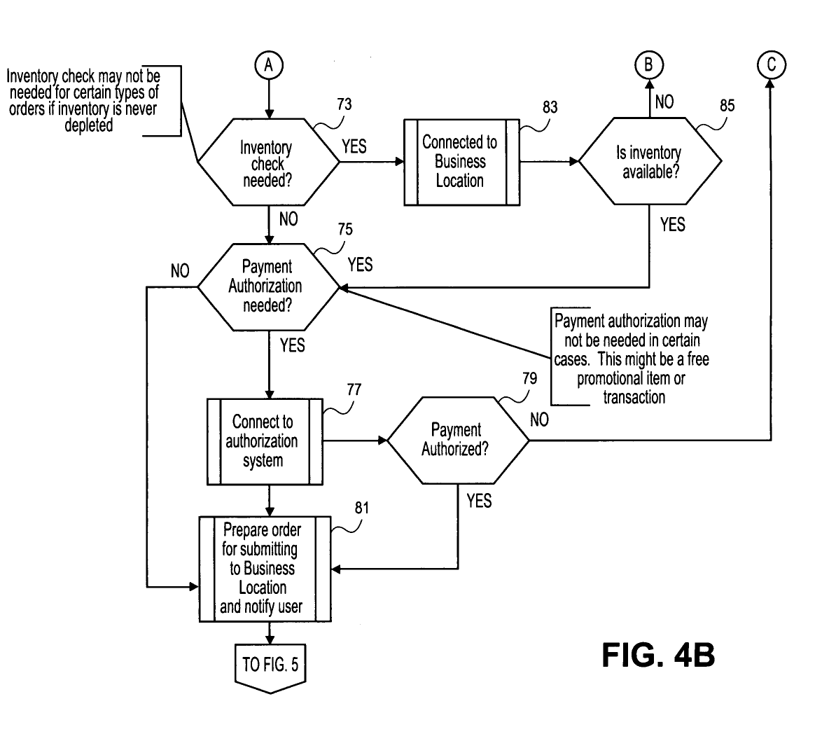

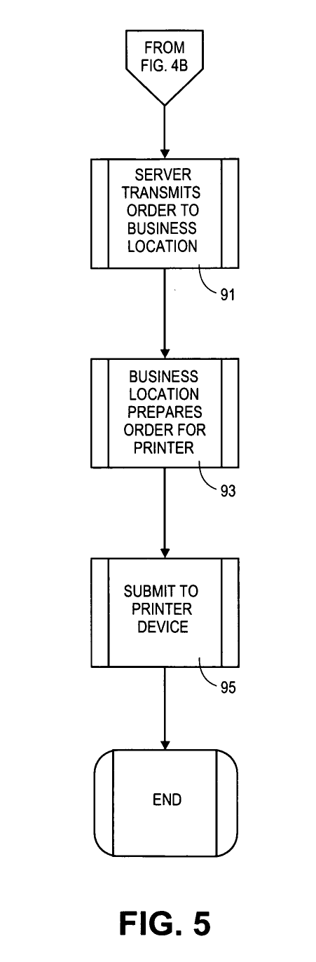

A more detailed description of the flow of information is now described with reference to FIGS. 4a, 4b and 5. At the start 61, after the user has selected a retail store of interest, an order entry screen is displayed for the user to enter an order 63. In some embodiments, a GPS device can provide input 65 identifying the current location of the user in which case instead of using the user's preference information to determine a desired store location, a store location closest to the current position can be used instead. After the request has been formatted as an instant message, the order is sent 67 as an instant message to transaction server 15 shown in FIG. 1. Transaction server 15 receives the information message and authenticates 69 the user by accessing the user information database 17 as described above. After authorization, a check 71 is made to see if more items need to be ordered. If yes, a user creates another request which is processed in the same manner. If no, a request is made to see if an inventory check 73 is needed. If no, for example, when an order is placed for an item such as coffee where no inventory check is needed, a check is made to see if payment authorization 75 is needed. If yes, a connection 77 is made to a credit card authorization system. If payment is authorized 79, the order is prepared 81 for submission to the business location and an instant message is sent to the user to notify the user that the request has been processed. If no payment authorization is needed, then the order can be immediately prepared 81 for submitting to the business location.

If an inventory check is needed, a connection is made to the business location 83 and an inventory check 85 is made. If there is adequate inventory to complete the order, payment authorization 75 is needed and the flow continues as described above. If inventory is not available, a reply 87 is sent back to the transaction server 15 which sends an instant message 89 back to the mobile user. Similarly, if the payment authorization step 79 returns a no, then an instant message 89 is sent back to the user that the transaction cannot be completed.

Processing continues with reference to FIGS. 4a, 4b and 5 where, an order is prepared for submitting to a business location 81, transaction server 15 transmits 91 the order to the business location, specifically to retail store printer server 19 shown in FIG. 1. The business location, i.e., retail store printer server prepares 93 the order for the printer and submits 95 the prepared order and sends it to the printer 25 which is automatically triggered to print the order.

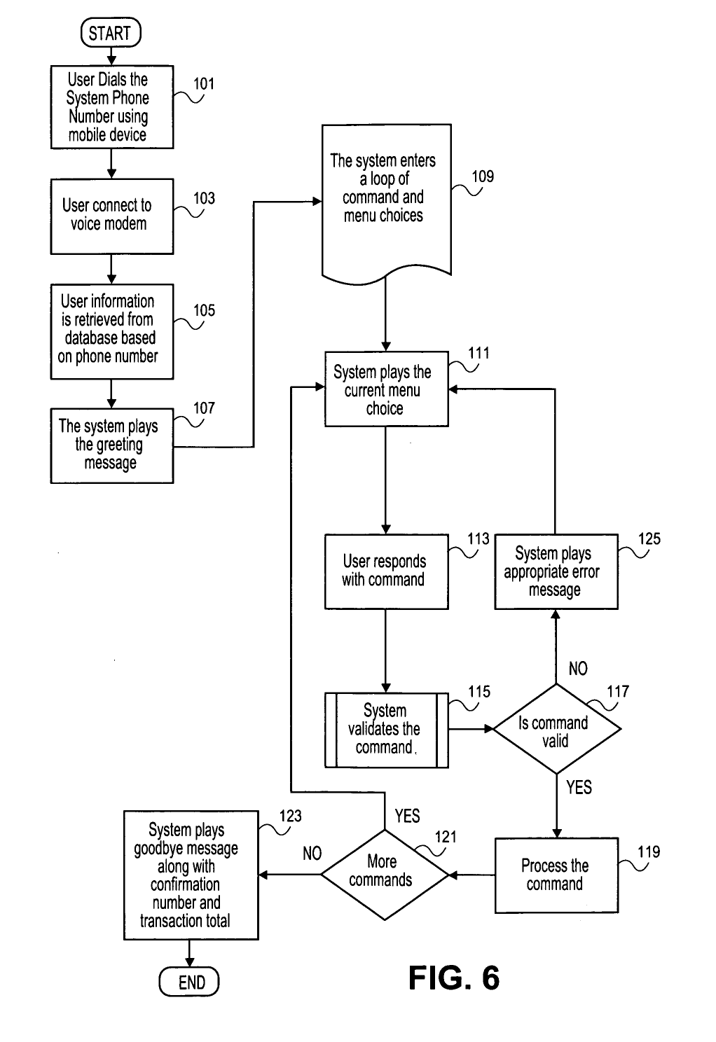

In another embodiment, orders can be placed over a cell phone or landline phone by voice commands which are processed by voice recognition software. That is, with reference to FIG. 1, messaging device 11 would be a regular cell phone or landline telephone. Mobile network service provider 13 would not need to incorporate a message gateway. Transaction server 15 would include voice recognition software. In this connection, with reference to FIG. 6, when a user desires to place an order, the user would dial a phone number to connect to the transaction server 15 with voice recognition software as provided in block 101. This would result in a connection to a voice modem as shown in block 103. Using known caller ID techniques, the phone number would retrieve user information from user information database 17 based on the phone number as shown in block 105. A server greeting message would be played at block 107. Then menu choices would be provided to the user by a prerecorded voice at block 109. The user, by pressing a key corresponding to a menu choice, or by speaking a command corresponding to a message choice, would result in the system playing back the menu choice at 111. The user would then respond with a spoken command at block 113. The spoken command would be validated by the system at block 115. If the command is valid, as determined by block 117, the command would be processed at block 119. The user would then be given a choice of whether to speak additional commands at block 121. If yes, the system loops back to block 111. If no, the system would play a good-bye message along with confirmation number and transaction cost at block 123. If it is determined that the command is not valid at block 117, then at block 125, the system plays an appropriate error message and returns to block 111. The foregoing menu selection choices and voice recognition techniques are all well known in the art. However, this embodiment of the invention is directed to the combination of using voice commands in conjunction with the remainder of the instant message system as described above.

In another embodiment, instead of using a messaging device such as a cell phone, in a browser environment on a desktop or laptop computer, while searching for a product of interest, clicking on a desired product displays a pop-up window in which the user can place ordering information as discussed above, and then click on a send button to send the order as if it were sent by a messaging device such as a cell phone. Further processing would then continue in the same manner as described.

In another embodiment, a web page is displayed containing either a served advertisement or icon that would advertise, promote or offer product information. The advertisement or icon is embedded with a transactional instant messaging software (widget). Once the user clicks on either the advertisement and/or icon, a small separate IM transactional window is enabled (widget). A transactional IM bot (widget) automatically initiates the offer to sell the product and/or services sold or promoted with the advertisement or icon. The user can request information via the instant messaging automated bot (widget) related to the product including pricing, delivery information and product availability but not limited thereto. The transactional bot is programmed with scripted responses which generate auto responses to the users questions and ultimately automatically transact the consummation of the sale by performing the processing described above with reference to FIGS. 1-5, except that, in this case, an automated bot would then trigger automatic payment with the following steps. Inventory is checked for the product requested by contacting the store directly or main data center that controls pricing and inventory. Credit card authorization through an existing payment system such as Cybercash™ available from PayPal, Inc. A confirmation number stored in database and user notification is provided. The transaction is logged into transaction server 15. The transaction is transmitted to the retail store or date center. Printer 25 is activated if needed to print the order.

The following is pseudo code for the server and client pieces on the web icons for a video store:

```
<?php
  include_once(“../functions.php”);
  $message = $_GET[‘message’];
  $id = $_GET[‘id’];
  $id = ‘edster9’;
  //$type = $_GET[‘type’];
  header(“Content-Type: text/html; charset=UTF-8”);
  $message = strtolower($message);
  $message = trim($message);
  // enum {BB_START = 0, BB_CONFIRM, BB_WANT_SNACKS, BB_SNACKS,
BB_PRINT, BB_NEW};
  $state = getState($id);
  if($message == ‘start’)
  {
    $state[0] = 0;
    $state[1] = ”;
    $state[2] = 0;
    setState($id, $state);
    echo “Welcome to the Video Store online agent. Ready for your command.”;
    die( );
  }
  else
  {
    if($state[0] == 0)
    {
      if($message == ‘new’)
      {
        // new movies messages
      }
      else if($message == “xxMovieNamexx”)
      {
        $state[0] = 1;
        $state[1] = ‘xxMovieNamexx’;
        $state[2] = 4.00
        setState($id, $state);
        echo “Please confirm your order of: $state[1] by responding with ‘Y’, your account
will be billed “ . ‘$4.00’ . ” and the movie delivered today. Type ‘N’ and you can try another
movie, type ‘I’ for more info?”;
      }
      else
      {
        echo “Unknown command... Please try again...”;
      }
      die( );
    }
    else if($state[0] == 1)
    {
      if($message == “y”)
      {
        $state[0] = 2;
        setState($id, $state);
        echo “Would you like to order snacks or drinks?”;
      }
      else if($message == “n”)
      {
        $state[0] = 0;
        $state[1] = ”;
        $state[2] = 0;
        setState($id, $state);
        echo “You have declined your movie order. Please choose another movie”;
      }
      else if($message == “i”)
      {
                // show movie spcific info
      }
      else
      {
        echo “Please confirm your order with a ‘Y’ or ‘N’ or ‘I’”;
      }
      die( );
    }
    else if($state[0] == 2)
    {
      if($message == “y”)
      {
        $state[0] = 3;
        setState($id, $state);
        echo “What movie snacks would you like?”;
        die( );
      }
      else if($message == “n”)
      {
        $state[0] = 4;
        setState($id, $state);
      }
      else
      {
        echo “Please answer with a ‘Y’ or ‘N’ Would you like to order snacks or drinks”;
        die( );
      }
    }
    else if($state[0] == 3)
    {
      if($message == “popcorn”)
      {
        $state[0] = 4;
        $state[2] += 1.50;
        setState($id, $state);
        echo “An order of popcorn has been added to your order for an additional $1.50”;
      }
      else if($message == “m&m”)
      {
        $state[0] = 4;
        $state[2] += 2.00;
        setState($id, $state);
        echo “An order of m&m has been added to your order for an additional $2.00”;
      }
      else if($message == “pepsi”)
      {
        $state[0] = 4;
        $state[2] += 2.50;
        setState($id, $state);
        echo “An order of pepsi six pack has been added to your order for an additional
$2.50”;
      }
      else
      {
        echo “Unknown snack. Choose from (Popcorn, Pepsi, m&m) or choose ‘n’ to
complete your order”;
      }
    }
  }
  if($state[0] == 4)
  {
    $dbc = encConnectToDB( );
    $datetime = mysql_current_date_text( );
    $query = “insert into bb_history (purchased, username, price, detail) values (‘$datetime’,
‘edster9’, $state[2], ‘$state[1]’)”;
    mysql_query($query, $dbc) or die(“Server Error 4”);
    $query = “select balance from creditcards where username = ‘edster9’ and merchantid =
2”;
    $result = mysql_query($query, $dbc) or die(“Server Error 4”);
    $db_balance = @mysql_result($result,0,“balance”);
    $db_balance −= $state[2];
    $query = “update creditcards set balance = $db_balance where username = ‘edster9’ and
merchantid = 2”;
    mysql_query($query, $dbc) or die(“Server Error 4”);
    $state[0] = 0;
    $state[1] = ”;
    $state[2] = 0;
    mysql_close($dbc);
    setState($id, $state);
    echo “\nYour order has been submitted to the Video Store and will arrive at your door
step shortly.”;
      die( );
  }
  function setState($user, $state)
  {
    $dbc = encConnectToDB( );
    $query = “select username from bb_sessions where username = ‘$user’”;
    $result = mysql_query($query, $dbc) or die(“Database error 1”);
    $num = mysql_numrows($result);
    if($num == 0)
    {
      $query = “insert into bb_sessions (username, bbstate, detail, price) values (‘$user’,
$state[0], ‘$state[1]’, $state[2])”;
      mysql_query($query, $dbc) or die(“Database error 2”);
    }
    else
    {
      $query = “update bb_sessions set bbstate = $state[0], detail = ‘$state[1]’, price =
$state[2] where username = ‘$user’”;
      //die($query);
      mysql_query($query, $dbc) or die(“Database Error 3”);
    }
    mysql_close($dbc);
  }
  function getState($user)
  {
    $dbc = encConnectToDB( );
    $query = “select bbstate, detail, price from bb_sessions where username = ‘$user’”;
    $result = mysql_query($query, $dbc) or die(“Database error 4”);
    $state = array( );
    $num = mysql_numrows($result);
    if($num > 0)
    {
      $state[0] = @mysql_result($result,0,“bbstate”);
      $state[1] = @mysql_result($result,0,“detail”);
      $state[2] = @mysql_result($result,0,“price”);
    }
    mysql_close($dbc);
    return $state;
  }
?>
OBJ
function bbCommand(command)
{
  document.getElementById(‘clickitCommand’).focus( );
  if(command.length == 0)
  {
    alert(‘Command can not be empty’);
    return;
  }
  var oXmlHttp = zXmlHttp.createRequest( );
  oXmlHttp.open(“get”, “../incomming.php?id=edster9&message=” + command, true);
  oXmlHttp.onreadystatechange = function ( )
  {
    if(oXmlHttp.readyState == 4)
    {
      //alert(oXmlHttp.responseText);
      bbResponse = oXmlHttp.responseText;
      // detect if the file was returned properly
      if(bbResponse.length == 0)
      {
        return;
      }
      else
      {
        document.getElementById(‘clickitText’).value += ‘\nClick It Mobile: -- ’ +
bbResponse + ‘\n--------------’;
        scrollElementToEnd(document.getElementById(‘clickitText’));
      }
    }
  }
  if(command != ‘start’)
  {
    document.getElementById(‘clickitText’).value += ‘\nMe: -- ’ + command +
‘\n--------------’;
    scrollElementToEnd(document.getElementById(‘clickitText’));
  }
  document.getElementById(‘clickitCommand’).value = ”;
  oXmlHttp.send(”);
}
function openvideostore( )
{
  document.getElementById(‘videostore’).style.visibility = ‘visible’;
  setTimeout(“createClickItMobile( )”, 25);
}
function closevideostore( )
{
  document.getElementById(‘videostore’).innerHTML = ”;
  setTimeout(“destroyClickItMobile( )”, 25);
}
function createClickItMobile( )
{
  clickitXSize += 10;
  clickitYSize += 6;
  document.getElementById(‘videostore’).style.width = clickitXSize;
  document.getElementById(‘videostore’).style.height = clickitYSize;
  if(clickitXSize == 400)
  {
    document.getElementById(‘videostore’).innerHTML = ‘<div style=“color:black;font-
weight:bold;”>Click It Mobile Online Agent</div>’ +
                                ‘<textarea id=“clickitText” cols=“60”
rows=“10”></textarea>’ +
                                ‘<br><br><div style=“color:black;font-
weight:bold;”>Command:&nbsp;<input id=“clickitCommand” type=“text”
size=“20”/>&nbsp;<input type=“button” value=“Send Command”
onclick=“bbCommand(document.getElementById(\‘clickitCommand\’).value);”/></div>’ +
                                ‘<br><br><div style=“float:right;”><input type=“button”
value=“Close Agent” onclick=“closevideostore( );”/></div>’;
    bbCommand(‘start’);
    return;
  }
  setTimeout(“createClickItMobile( )”, 25);
}
function destroyClickItMobile( )
{
  clickitXSize −= 10;
  clickitYSize −= 6;
  document.getElementById(‘videostore’).style.width = clickitXSize;
  document.getElementById(‘videostore’).style.height = clickitYSize;
  if(clickitXSize == 0)
  {
    document.getElementById(‘videostore’).style.visibility = ‘hidden’;
    return;
  }
  setTimeout(“destroyClickItMobile( )”, 25);
}
// html insert
    <img src=“videostore.jpg” onclick=”openvideostore( );”/>
```

In another embodiment, by using the present invention, a consumer is able to walk into any retail store and look at, test, and try products, in addition to placing orders when away from a retail store.

When the consumer decides on the product that he/she would like to buy, the consumer can send a text message or instant message to transaction server 15 with the information on the product they are interested in buying. The transaction server enables the text message or instant message that it receives to interface with a retail store data base server, check for inventory, pricing, availability and shipping information as described above.

Once the transaction server 15 qualifies all of the information as described in the above paragraph, in one embodiment, the transaction server can auto transmit the lowest available price via text message or instant message back to the consumer in the retail store. Within seconds the consumer in the retail store now has instantaneous pricing and availability information.

The consumer can now send, via text message or instant message, a simple acknowledgement or acceptance from their mobile phone back to the transaction server and place an instant order for the lowest priced product that the consumer previously received from their interaction with the transaction server via text or instant messaging service.

After the consumer enters a pin code to verify identity, the order will be placed and the product would then be shipped to the consumers default address.

Specific uses of this invention will now be described.

### Video Store Application

A registered user will simply send a Text Message (SMS) or Instant Message (IM) of a movie title to the transaction server 15. The transaction server will route the request to a designated video store of the registered user and trigger in store printer 25 to automatically print out the order. An associate from the video store could then deliver the video to the registered users' home address on file, or the video can be held for pickup so the registered user can go to the store and the video is waiting for them. The user will then have the option of returning the movie to any store location, dropping it in the mail in a prepaid envelope or having the associate pick up when another movie is delivered. Users' will not have to wait to obtain videos through the mail. Videos can be delivered directly to the user.

In one embodiment, instead of the user entering a movie title, the system can push to the user new releases (in the form of a text message (SMS) or Instant Message) which would be displayed. The user could then select one of the displayed new releases, and click a send button to initiate an order as described above.

Example instant messages for this embodiment:

get new movies

show top 5 movies

An example of the content of an instant message for placing an order for a dvd with the title XYZ would be as follows:

### Store identification, user name, dvd, XYZ

### Coffee Store Application

People have made stopping for coffee each day a part of their morning ritual. Day after day customers wait in line for their morning coffee before heading to the office. The invented system will simplify this daily ritual for not only the consumer but the store.

The consumer registers with the service as described above. The registration process involves the consumer registering their cell phone number and credit information. The consumer will then be able to Text Message (SMS) or Instant Message (IM) their order to the coffee store location of their choice. Once the consumer sends the order they are also authorizing the charge to their credit facility, either a credit card, a debit card, or a pre-purchased credit. They will then just stop in and pick up their order. The invention enables a completely automated transaction for the consumer. The consumer will not need to wait on hold while calling in an order, or give credit card information over the phone.

Once the consumer has sent their order via Text Message (SMS) or Instant Message (IM), the order is routed to the closest chosen store, the in store printer 25 is automatically triggered to print the order thereby alerting the store they have an order to fill. If the consumer has a GPS enabled mobile device, the order can be routed to the closest store based on the GPS information. The order will be filled and the consumer will then have a special “pick up” line to go to as no payment will be needed. The invention allows stores to process orders in a timelier fashion as the “cash handling” aspect of the transaction will no longer be needed for these customers.

An example of the content of an instant message for placing an order for a medium latte with vanilla flavoring would be as follows:

(outgoing) medium non fat latte

(incoming) total 3.50 confirm (y,n)

(outgoing) y

(incoming) confirmed . . . please go to the store location for pickup

### Pharmacy Application

The invention will also enable doctor's office to text message (SMS) or Instant Message (IM) prescriptions to pharmacies, which will enable consumers to have their prescriptions filled without having to drop off a paper prescription. By embedding a vendor print server into pharmacies, the invention offers faster and safer prescription handling for the consumer. The text message flows through the transaction server 15, the credit card is charged for the purchase and the text order is routed to the chosen pharmacy.

Each year millions of prescriptions are filled using a paper based system. The existing paper prescription system is not only antiquated, but can lead to improperly filled prescriptions due the amount of human interaction required between the doctor's office and a pharmacy. The invention will help ensure that prescriptions are being filled properly.

The doctor's office registers with the transaction server and each doctor within that office is assigned a password.

If the doctor needs to prescribe medication for a patient, the doctor writes a prescription in his/her office for a patient. The doctor/nurse/assistant then sends a text or IM (instant message) message to a participating pharmacy with the details of the prescription. The pharmacy receives the text or IM message with the prescription and an authorization request code is automatically sent back to the doctors office for validation and verification. The doctor's office receives an IM with a request for a secret PIN code from the doctors office, and an authorized person at the doctors office responds with the PIN number. The authorization is received at the pharmacy, the customers order automatically triggers a running computer program, and a printer is auto triggered by the IM or Text (SMS). The order is printed at the pharmacy and the credit card of the customer will be auto billed. The prescription will be ready for the customer when he/she arrives at the pharmacy location.

An example of the content of an instant message for placing a prescription order for the drug XYZ would be as follows:

Store identification, patient name, doctor name, XYZ

The present invention is not limited by the specific applications and examples provided herein which are set forth for illustration purposes, but only as required by the following claims.

What is claimed is:

1. A system for ordering products or services using an instant messaging device comprising:
a) a first module configured to receive an instant message originating from an instant messaging device, said instant message including user identification information, vendor information and product or service order information;
b) a second module coupled to said first module, said second module configured to obtain authenticate said user identification information and obtain additional user information from a database accessible by said second module;
c) a third module coupled to said second module configured to communicate with a vendor module to obtain availability and pricing information using said product or service order information and initiate a product or service order, wherein said vendor module causes said product or service order to be automatically printed on a printer associated with said vendor module.

2. The system defined by claim 1 wherein said first module comprises:
an instant messaging interface which operates to convert said user identification information, vendor information and product or service order information contained in said received instant message to a form usable by said second module.

3. The system defined by claim 1 wherein said second module comprises:
a processing engine which utilizes said user identification information, vendor information and product or service order information received from said first module to access said database, locate a record corresponding to said user information and retrieve said additional user information, said additional user information including credit card data and user preference data.

4. The system defined by claim 1 wherein said third module is further configured to communicate with a credit authorization system to cause a charge to be applied to an account of said user based on said pricing information and said additional user information.

5. The system defined by claim 4 wherein said third module comprises:
a) an outbound connection manager coupled to said second module;
b) a credit authorization module coupled to said outbound connection module and configured to communicate with said credit authorization system
c) a vendor location connection manager coupled to said outbound connection module and configured to communicate with said vendor module to obtain said availability and pricing information.

6. A system for ordering products or services using an instant messaging device comprising:
a) a vendor module configured to receive product or service order information initiated by an instant messaging device and generate an order for printing using said received product or service order information;
b) a printer coupled to said vendor module and configured to automatically print said order.

7. The system defined by claim 6 wherein said vendor module is further configured to:
a) process said received product or service order information by
i) checking said order information to verify that it can be completed,
ii) determining an amount to be charged for said order, and
iii) transmitting a transaction record containing said amount;
b) receiving a transaction record contain a confirmation that said amount has been charged;
c) formatting said order for said printer;
d) sending said formatted order to said printer to be automatically printed.

8. A system for ordering products or services using an instant messaging device comprising:
a) an instant messaging device configured to display vendor icons;
b) a first module configured to display an order entry form based on a selected one of said vendor icons;
c) a second module configured to format an instant message using information entered using said displayed order entry form and send an instant message to a first remote server, said instant message including user identification information, vendor information and product or service order information, said first remote server configured to receive said instant message and initiate a process for sending order information based on said received instant message to a second remote server, said second remote server configured to receive said order information and generate an order to be automatically printed on a printer associated with said second remote server.

9. The system defined by claim 8 wherein said first module comprises:
an instant messaging interface which operates to convert said user identification information, vendor information and product or service order information contained in said received instant message to a form usable by said second module.

10. The system defined by claim 8 wherein said first remote server comprises:
a processing engine which utilizes said user identification information, vendor information and product or service order information received from said messaging device to access said database, locate a record corresponding to said user information and retrieve said additional user information, said additional user information including credit authorization data and user preference data.

11. The system defined by claim 8 wherein said first remote server is configured to communicate with a credit authorization system to cause a charge to be applied to an account of said user based on said pricing information and said additional user information.

12. The system defined by claim 8 wherein said second remote server comprises:
a) a vendor module configured to receive product or service order information initiated by said instant messaging device and generate an order for printing using said received product or service order information;
b) said printer coupled to said vendor module and configured to automatically print said order.

13. A system for ordering products or services using voice commands comprising:
a) a vendor module configured to receive voice commands from a voice source and convert the received voice commands to product or service order information and generate an order for printing using said received product or service order information;
b) a printer coupled to said vendor module and configured to automatically print said order.

14. The system defined by claim 13 wherein said vendor module is further configured to:
a) process said received product or service order information by
i) checking said order information to verify that it can be completed,
ii) determining an amount to be charged for said order, and
iii) transmitting a transaction record containing said amount;
b) receiving a transaction record contain a confirmation that said amount has been charged;
c) formatting said order for said printer;
d) sending said formatted order to said printer to be automatically printed.

15. A system for ordering products or services using a web page having embedded transactional instant messaging software comprising:
a) a first module configured to generate a web page which includes icons which when selected by a user, enable a user to enter ordering information for a product or service;
b) a second module configured to format an instant message using information entered by said user and send an instant message to a first remote server, said instant message including user identification information, vendor information and product or service order information, said first remote server configured to receive said instant message and initiate a process for sending order information based on said received instant message to a second remote server, said second remote server configured to receive said order information and generate an order to be automatically printed on a printer associated with said second remote server.

16. The system defined by claim 15 wherein said first module comprises:
an instant messaging interface which operates to convert said user identification information, vendor information and product or service order information contained in said received instant message to a form usable by said second module.

17. The system defined by claim 15 wherein said first remote server comprises:
a processing engine which utilizes said received user identification information, vendor information and product or service order information to access said database, locate a record corresponding to said user information and retrieve said additional user information, said additional user information including credit authorization data and user preference data.

18. The system defined by claim 15 wherein said first remote server is configured to communicate with a credit authorization system to cause a charge to be applied to an account of said user based on said pricing information and said additional user information.

19. The system defined by claim 15 wherein said second remote server comprises:
a) a vendor module configured to receive product or service order information initiated by said user and generate an order for printing using said received product or service order information;
b) said printer coupled to said vendor module and configured to automatically print said order.
